(19) United States
(12) Patent Application Publication
(10) Pub. No.: US 2017/0041282 A1
(43) Pub. Date: Feb. 9, 2017

(54) Global Digital Mobile Publishing (GDMP) Method

(71) Applicant: New5 TV Co., Ltd., Taipei City (TW)

(72) Inventor: Cheng-Tzuu Hsia, Taipei City (TW)

(21) Appl. No.: 14/819,487

(22) Filed: Aug. 6, 2015

(51) Int. Cl. H04L 12/58; H04W 4/14; H04L 29/08

(52) U.S. Cl. CPC H04L 51/36; H04L 51/38; H04L 67/06; H04W 4/14; H04L 67/10

(57) ABSTRACT

A GDMP method includes: providing an open platform for distributing an EDM employing an open file format, a closed platform including a GDMP system, and a mobile device having a special-purpose application installed thereon; when the GDMP system receives order information about a product on the EDM and confirms the product has been paid, the GDMP system sending a user an electronic message including identification information according to contact information about the user included in the order information; when the special-purpose application is executed on the mobile device and the identification information is input, the GDMP system transmitting a content of the product employing a closed file format formed by encryption and encoding to the mobile device to store, and bounding the stored content of the product to the mobile device; and, executing the special-purpose application on the mobile device to play the stored content of the product. It employs the open platform to make the distribution of products for sale easy to achieve better advertising effectiveness, and employs the closed platform to prevent sold products from illegal spread to protect owners of products.

### BACKGROUND OF THE INVENTION

1. Field of the Invention

The present invention relates to a digital content publishing method. More particularly, the present invention relates to a digital content publishing method used in mobile devices.

2. Description of the Prior Art

With the popularity of mobile devices such as mobile phones, various digital content publishing methods used in mobile devices have been developed. However, these methods neither make the distribution of products for sale easy to achieve better advertising effectiveness, nor prevent sold products from illegal spread to protect owners of products.

### SUMMARY OF THE INVENTION

The present invention is adapted to providing a global digital mobile publishing (GDMP) method capable of making the distribution of products for sale easy to achieve better advertising effectiveness, and preventing sold products from illegal spread to protect owners of products.

According to an aspect of the present invention, a GDMP method is provided. The GDMP method includes: providing an open platform for distributing an electronic direct mail (EDM) employing an open file format; providing a closed platform including a GDMP system; when the GDMP system receives order information about a product on the EDM from the open platform and confirms the product has been paid, the GDMP system sending a user an electronic message including identification information according to contact information about the user included in the order information; providing a mobile device having a special-purpose application installed thereon; when the special-purpose application is executed on the mobile device and the identification information is input, the GDMP system transmitting a content of the product employing a closed file format formed by encryption and encoding to the mobile device to store, and bounding the content of the product stored in the mobile device to the mobile device; and, executing the special-purpose application on the mobile device to play the content of the product stored in the mobile device.

According to another aspect of the present invention, the GDMP method further includes: when the mobile device receives the EDM distributed on the open platform, the mobile device displaying the EDM for the user to select and order the product.

According to another aspect of the present invention, the GDMP method further includes: when the product on the EDM is selected, the mobile device playing a trial content of the product; and, when the product on the EDM is ordered, the mobile device generating and sending the order information to the GDMP system.

According to another aspect of the present invention, the GDMP method further includes: when the mobile device receives the electronic message, the mobile device downloading the special-purpose application from the GDMP system according to a web address or a hyperlink included in the electronic message.

According to another aspect of the present invention, the mobile device includes a mobile phone or a mobile computer.

According to another aspect of the present invention, the content of the product includes an audio, a music video (MV), a movie, or a video.

According to another aspect of the present invention, the identification information includes an account name and a password.

According to another aspect of the present invention, the electronic message includes an electronic mail (email) or a short message service (SMS) message.

It is remarked that the aforementioned aspects or features can also be combined with each other and are in the scope of the present invention as well.

In summary, the present invention employs the open platform to make the distribution of products for sale easy to achieve better advertising effectiveness, and employs the closed platform to prevent sold products from illegal spread to protect owners of products.

### BRIEF DESCRIPTION OF THE DRAWINGS

The foregoing and other features of the present invention will be apparent and easily understood from a further reading of the specification, claims and by reference to the accompanying drawings in which:

FIG. 1 is a flowchart of a GDMP method according to an embodiment of the present invention.

### DESCRIPTION OF THE PREFERRED EMBODIMENTS

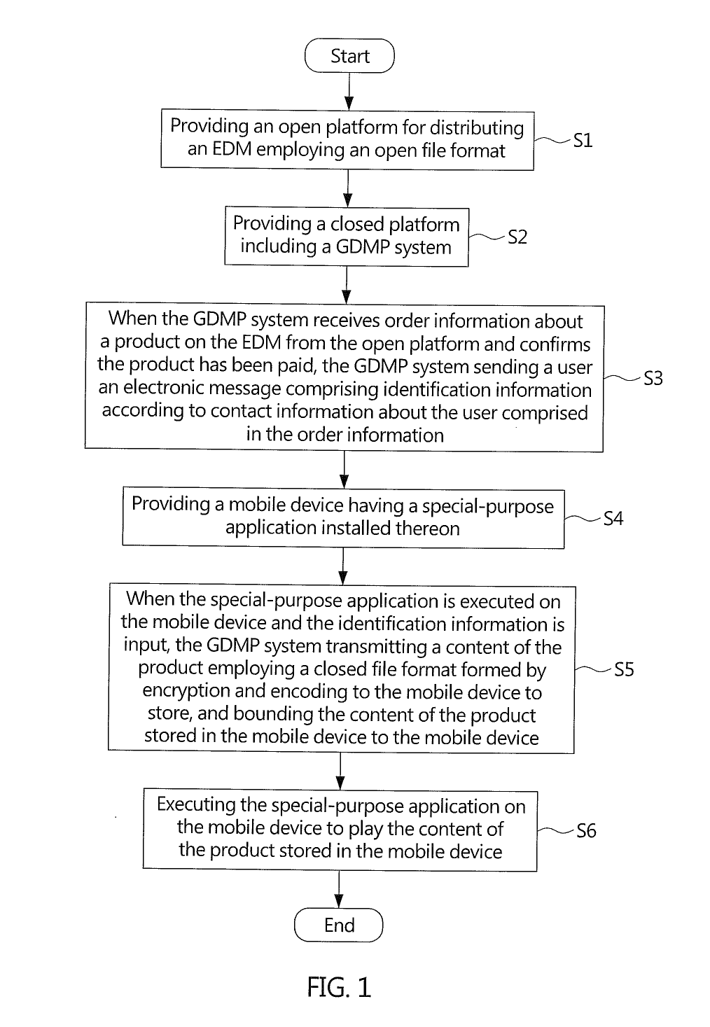

Referring to FIG. 1, there is provided a flowchart of a GDMP method according to an embodiment of the present invention. At step S1, an open platform is provided for distributing an EDM employing an open file format. The open platform includes, for example, a website, an electronic device, a general-purpose application, or a combination thereof, only if they may transmit and/or play the EDM employing the open file format. The website includes, for example, a video sharing website (e.g. Youku), a web portal (e.g. Sohu), or a social networking service (e.g. Facebook). The electronic device includes, for example, a mobile device having a function of mobile communication (e.g. a mobile phone or a mobile computer), or a device having a function of net surfing (e.g. a personal computer or a server). The general-purpose application includes, for example, a media player (e.g. Media Player Classic or iTunes). Moreover, the open file format includes, for example, an audio file format (e.g. OGG), a video file format (e.g. MKV), or any other multimedia file format. Because the EDM employs the open file format, the EDM may be played by a general-purpose application, so it may be easily transmitted between users to achieve better advertising effectiveness.

In an embodiment, a user may use a mobile phone to receive the EDM employing the open file format. When the mobile phone receives the EDM distributed on the open platform, the mobile phone may display the EDM for the user to select and order a product on the EDM. When the product on the EDM is selected, the mobile phone may open the corresponding general-purpose application installed thereon to play a trial content of the product. The content of the product includes, for example, an audio, a MV, a movie, a video, or any other multimedia.

Moreover, if the user wants to buy the product after listening and/or seeing the trial content of the product, the user may use the mobile phone to order the product online. When the product on the EDM is ordered, the mobile phone may generate and send order information. Then, the user may use the mobile phone to pay the product online or offline. The online payment includes, for example, a credit card or a web automated teller machine (Web ATM). The offline payment includes, for example, an over-the-counter or an automated teller machine (ATM). In another embodiment, the user may use a desktop computer having a function of net surfing to receive the EDM employing the open file format, select the product on the EDM, and pay the product online or offline.

At step S2, a closed platform is provided. The closed platform includes a GDMP system. The GDMP system includes, for example, a server and a database. The server has a server software installed thereon for managing resources and providing services through a network for users including a manufacture, a vendor or a consumer. The services include, for example, an advertisement production service for providing the manufacture or vendor to produce an EDM employing an open file format, an automatic transmitting service for automatically transmitting EDMs on the open platform, etc. The database is for storing EDMs produced by manufactures or vendors, a special-purpose application, etc.

At step S3, when the server of the GDMP system receives the order information about the product on the EDM from the open platform and confirms the product has been paid, the server of the GDMP system sends the user an electronic message including identification information according to contact information about the user included in the order information. The contact information about the user includes, for example, an email address or a mobile phone number about the user. The electronic message includes, for example, an email or a SMS message. The identification information included in the electronic message includes, for example, an account name and a password about the user.

Therefore, the EDM needs to be design to request the user to input the contact information when the user is ordering the product, so that the contact information is included in the order information about the product, and then the order information including the contact information is sent to the server of the GDMP system through the electronic device having the function of mobile communication or net surfing.

At step S4, a mobile device is provided. The mobile device may have a special-purpose application installed thereon. The mobile device includes, for example, a mobile phone, a mobile computer, or any other device having a function of mobile communication. The mobile phone includes, for example, a mobile phone. The mobile computer includes, for example, a tablet computer or a personal digital assistant (PDA).

If the mobile device does not have the special-purpose application installed thereon, it may automatically or manually download the special-purpose application from the database of the GDMP system and then install the special-purpose application on the mobile device. In an embodiment, because the server of the GDMP system always sends the user the electronic message including a web address or a hyperlink for downloading the special-purpose application, when the mobile device receives the electronic message, the mobile device may download the special-purpose application from the database of the GDMP system according to the web address or the hyperlink included in the electronic message, and then may install the special-purpose application on the mobile device. In another embodiment, the user may use a desktop computer having a function of net surfing to download the special-purpose application from the database of the GDMP system according to the input of the known web address or the known hyperlink, and then may copy or transmit the special-purpose application to the mobile device to install.

At step S5, when the special-purpose application is executed on the mobile device and the identification information is input, and then the input identification information is confirmed by the server of the GDMP system, the server of the GDMP system transmits a full content of the product employing a closed file format formed by encryption and encoding to the mobile device to store. Moreover, the server of the

GDMP system bounds the content of the product stored in the mobile device to the mobile device.

Many bounding techniques have been developed. In a conventional case, the server of the GDMP system uses a hardware parameter of the mobile device and/or a software serial number of the special-purpose application installed on the mobile device to generate an individual identification code. The hardware parameter of the mobile device includes, for example, an international mobile equipment identity (IMED or an international mobile subscriber identity (IMSI). Then, the server of the GDMP system adds the individual identification code during forming the content of the product employing the closed file format. Therefore, when the special-purpose application is executed on the mobile device to play the content of the product stored in the mobile device, the individual identification code can be used to determine whether the content of the product is played on a correct mobile device or not.

At step S6, the special-purpose application is executed on the mobile device to play the content of the product stored in the mobile device. Because the content of the product stored in the mobile device employs the closed file format and is bound to the mobile device, the content of the product can be only played by the special-purpose application on the bound mobile device, it may prevent sold products from illegal spread to protect owners of products.

Although the present invention is disclosed in the aforementioned embodiments, the embodiments are not intended to limit the scope of the present invention. For example, the step S4 may be performed at the beginning (e.g. before the step S1), or between the steps S1 and S2, or between the steps S2 and S3.

It will be apparent to those skilled in the art that various modifications and variations can be made to the structure of the present invention without departing from the scope or spirit of the present invention. In view of the foregoing, it is intended that the present invention cover modifications and variations of this invention provided they fall within the scope of the following claims and their equivalents.

What is claimed is:

1. A global digital mobile publishing (GDMP) method, comprising:
providing an open platform for distributing an electronic direct mail (EDM) employing an open file format;
providing a closed platform comprising a GDMP system;
when the GDMP system receives order information about a product on the EDM from the open platform and confirms the product has been paid, the GDMP system sending a user an electronic message comprising identification information according to contact information about the user comprised in the order information;
providing a mobile device having a special-purpose application installed thereon;
when the special-purpose application is executed on the mobile device and the identification information is input, the GDMP system transmitting a content of the product employing a closed file format formed by encryption and encoding to the mobile device to store, and bounding the content of the product stored in the mobile device to the mobile device; and
executing the special-purpose application on the mobile device to play the content of the product stored in the mobile device.

2. The GDMP method of claim 1, further comprising:
when the mobile device receives the EDM distributed on the open platform, the mobile device displaying the EDM for the user to select and order the product.

3. The GDMP method of claim 2, further comprising:
when the product on the EDM is selected, the mobile device playing a trial content of the product; and
when the product on the EDM is ordered, the mobile device generating and sending the order information to the GDMP system.

4. The GDMP method of claim 1, further comprising:
when the mobile device receives the electronic message, the mobile device downloading the special-purpose application from the GDMP system according to a web address or a hyperlink comprised in the electronic message.

5. The GDMP method of claim 1, wherein the mobile device comprises a mobile phone or a mobile computer.

6. The GDMP method of claim 1, wherein the content of the product comprises an audio, a music video (MV), a movie, or a video.

7. The GDMP method of claim 1, wherein the identification information comprises an account name and a password.

8. The GDMP method of claim 1, wherein the electronic message comprises an electronic mail (email) or a short message service (SMS) message.
